(19) United States
(12) Patent Application Publication
(10) Pub. No.: US 2024/0291690 A1
(43) Pub. Date: Aug. 29, 2024

(54) METHOD FOR FACILITATING JOINT CHANNEL ESTIMATION AT A TRANSMISSION DISRUPTION

(71) Applicant: Sony Group Corporation, Tokyo (JP)

(72) Inventors: Erik BENGTSSON, Eslöv (SE); Kun ZHAO, Malmö (SE); Fredrik RUSEK, Eslöv (SE); José FLORDELIS, Lund (SE); Olof ZANDER, Södra Sandby (SE)

(21) Appl. No.: 18/573,140

(22) PCT Filed: Jun. 23, 2022
(86) PCT No.: PCT/EP2022/067282

§ 371 Date: Dec. 21, 2023

(30) Foreign Application Priority Data
Jul. 29, 2021 (SE) 2150976-5

(51) Int. Cl. H04L 25/02; H04L 5/00; H04W 72/0453; H04W 72/51

(52) U.S. Cl. CPC H04L 25/0204; H04L 5/0051; H04W 72/0453; H04W 72/51

(57) ABSTRACT

A method carried out in a radio node of a wireless network for facilitating joint channel estimation in communication with a User Equipment, UE, the method comprising: providing (702), to the UE, radio configuration for a channel (PUSCH, PUCCH) identifying resources for Uplink, UL, transmission within a first frequency domain allocation (83); configuring (704) the UE to transmit, in reference signal resources associated with the radio configuration, a reference signal (DMRS) for use in the radio node for joint channel estimation, wherein said reference signal resources comprise first reference signal resources (81) allocated within said first frequency domain allocation, and second reference signal resources (82) outside said first frequency domain allocation to facilitate joint channel estimation over a transmission disruption within the first frequency domain allocation.

### TECHNICAL FIELD

This disclosure is related to wireless communication between a wireless device and a radio node of a wireless system, such as an access node of a wireless network. Specifically, solutions are provided for facilitating improved channel estimation in the radio node based on reference signals transmitted by the wireless device. The proposed solutions are suitable for use in case of transmission discontinuity from the wireless device and particularly when communication is configured over a narrow bandwidth allocation.

### BACKGROUND

Various protocols and technical requirements for wireless communication have been standardized under supervision of inter alia the 3^{rd} Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication. In various scenarios, the UE may be configured to communicate directly with another wireless device. This may for certain applications be referred to as sidelink communication in 3GPP specifications.

One issue that needs to be considered in wireless communication is channel estimation carried out in a radio node. One example is such channel estimation for a Physical Uplink Shared Channel (PUSCH) or a Physical Uplink Control Channel (PUCCH). Such channel estimation may be conducted in the access node, forming the radio node, based on a reference signal, or pilot signal, received from the UE. In an alternative but related scenario, channel estimation may be carried out in another wireless device acting as radio node, such as in sidelink communication.

The UE will typically be configured to communicate with the radio node, at least in UL, according to a certain radio configuration, such as on a PUSCH or PUCCH channel. In order for the radio node to accomplish channel estimation, the UE is further configured to transmit reference signals, such as demodulation reference signals (DMRS), according to a reference signal configuration. The reference signal configuration may identify various resources of the radio configuration dedicated to reference signal transmission.

A scenario where challenges exist in the need for obtaining reference signals in the radio node to accomplish channel estimation is when a disruption in transmission from the UE occurs on the channel. Such disruption or discontinuity may lead to an inconsistency in the UL signals, e.g. a phase shift or an amplitude discontinuity caused by the UE switching between UL and DL, or signal inconsistency caused by an UL transmission being interrupted by a different type of UL transmission. The difference between the types of UL transmission may e.g. relate to transmission discontinuity based on changes in hardware or software settings, e.g. power level, timing advance adjustment, beam direction etc. In this context, it may be particularly challenging to obtain channel estimation where the radio configuration is provided for narrow bandwidth, such as with a frequency domain allocation of one or a few physical resource blocks (PRB) in an NR system.

### SUMMARY

In view of the foregoing, solutions are presented herein for facilitating channel estimation in a radio node in communication with a UE. The invention is defined by the independent claims, whereas various further advantageous features are set out in the dependent claims.

According to one aspect, a method carried out in a UE is provided, for facilitating joint channel estimation in a radio node of a wireless network, the method comprising:
obtaining radio configuration for a channel, identifying resources for UL transmission within a first frequency domain allocation;
transmitting, in reference signal resources associated with the radio configuration, a reference signal for use in the radio node for joint channel estimation,
wherein said reference signal resources comprise first reference signal resources within said first frequency domain allocation, and second reference signal resources outside said first frequency domain allocation to facilitate joint channel estimation over a transmission disruption within the first frequency domain allocation.

According to another aspect, a method carried out in a radio node of a wireless network is provided, for facilitating joint channel estimation in communication with a UE the method comprising:
providing, to the UE, radio configuration for a channel identifying resources for UL transmission within a first frequency domain allocation;
configuring the UE to transmit, in reference signal resources associated with the radio configuration, a reference signal for use in the radio node for joint channel estimation,
wherein said reference signal resources comprise first reference signal resources allocated within said first frequency domain allocation, and second reference signal resources outside said first frequency domain allocation to facilitate joint channel estimation over a transmission disruption within the first frequency domain allocation.

### BRIEF DESCRIPTION OF THE DRAWINGS

FIG. 1 schematically illustrates an implementation of a wireless communication system, in which a UE communicates with a radio node, such as an access node of wireless network or another wireless device.

FIG. 2 schematically illustrates a UE configured to communicate with the wireless network according to various embodiments.

FIG. 3 schematically illustrates an access node of the wireless network according to various embodiments.

FIG. 4 provides an illustration of an example of a narrowband UL signal according to a radio configuration confined to one PRB with resources allocated for DMRS, wherein the radio configuration provides for a transmission disruption by means of a discontinuity for interrupting DL traffic.

FIG. 5 shows DMRS mapping of a particular PUCCH format 3, which can be seen as a version of FIG. 4, wherein UL signals are transmitted in resources allocated in two PRBs separated by a configurable frequency gap.

FIG. 6 illustrates different steps which may be included in various embodiments of the proposed solution in a method carried out in a UE.

FIG. 7 illustrates different steps which may be included in various embodiments of the proposed solution in a method carried out in a radio node.

FIG. 8 schematically shows an embodiment in which reference signals are transmitted in resources allocated, outside the frequency domain allocation of the UL channel.

FIG. 9 schematically illustrates an embodiment in which the radio configuration provides for allocation of UL resources in a first frequency domain allocation, with additional PRBs at a transmission disruption, wherein the additional PRBs comprise allocation of resources for reference signal transmission outside the first frequency domain allocation.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. The description below further describes the single input single output (SISO) or single input multiple output (SIMO) scenario with a single transmission layer. It shall, however, be obvious to a person skilled in the art that similar approach can be applied vis-a-vis to the multiple input multiple output (MIMO) scenario, where the UE is configured with multiple simultaneous transmission layers, associated with multiple antenna configurations. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

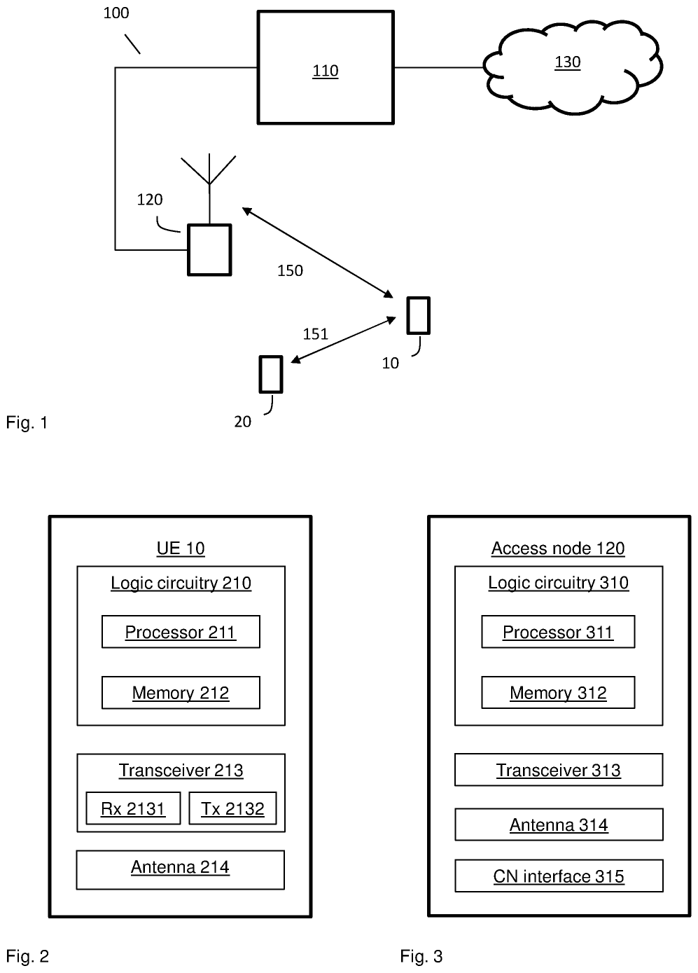

FIG. 1 illustrates a high-level perspective of operation of a UE 10 in a wireless network 100. The wireless network 100 may be a radio communication network 100, configured to operate under the provisions of 5G NR as specified by 3GPP, according to various embodiments outlined herein. The wireless network 100 may comprise a core network 110, which in turn may comprise a plurality of core network nodes. The core network is connected to at least one access network comprising one or more base stations or access nodes, of which one access node 120 is illustrated. The access node 120 is a radio node configured for wireless communication on a physical channel 150 with various UEs, of which only the UE 10 is shown. The core network 110 may in turn be connected to other networks 130. The UE 10 may further be configured to communicate directly with a wireless device 20 acting as radio node, such as another UE, in device-to device (D2D) communication, e.g. on a sidelink physical channel 151.

Before discussing further details and aspects of the proposed method, functional elements for the UE 10, configured to carry out the proposed solution, will be briefly discussed.

FIG. 2 schematically illustrates an example of the UE 10 for use in a wireless network 100 as presented herein, and for carrying out various method steps as outlined.

The UE 10 comprises a radio transceiver 213 for communicating with other entities of the radio communication network 100, such as the access node 120, in different frequency bands. The transceiver 213 may thus include a receiver chain (Rx) 2131 and a transmitter chain (Tx) 2132, for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception. The antenna system 214 may comprise different antenna ports, to which the Rx 2131 and the Tx 2132, respectively, may selectively be connected. For this purpose, the antenna system 214 may comprise an antenna switch.

The UE 10 further comprises logic circuitry 210 configured to communicate data and control signals, via the radio transceiver, on a physical channel 150 to the wireless communication network 100, or on a physical channel 151 to a wireless device 20.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

Obviously, the UE 10 may include other features and elements than those shown in the drawing or described herein, such as a power supply, a casing, a user interface, sensors, etc., but these are left out for the sake of simplicity.

FIG. 3 schematically illustrates a radio node in the form of an access node 120 of the wireless network 100 as presented herein, and for carrying out the method steps as outlined. In various embodiments, the access node 120 is a radio base station for operation in the radio communication network 100, to serve one or more radio UEs, such as the UE 10.

The access node 120 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 120 further comprises logic circuitry 310 configured to control the access node 120 to communicate with the UE 10 via the radio transceiver 313 on a physical channel 150.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 120 to carry out any of the method steps as provided herein. Software defined by said computer program code may include an application or a program that provides a function and/or a process. The software may include device firmware, an operating system (OS), or a variety of applications that may execute in the logic 310.

The access node 120 may further comprise, or be connected to, an antenna 314, which may include an antenna array. The logic 310 may further be configured to control the radio transceiver to employ an anisotropic sensitivity profile of the antenna array to transmit radio signals in a particular transmit direction. The access node 120 may further comprise an interface 315, configured for communication with the core network 110. Obviously, the access node 120 may include other features and elements than those shown in the drawing or described herein, such as a power supply and a casing etc.

One challenge associated with channel estimation is related to Joint Channel Estimation (JCE) for the channel, such as PUSCH, based on at least two demodulation reference signals (DMRS) transmitted from the UE, i.e. two occasions of transmission of the DMRS, to jointly estimate a reference condition such as channel phase and amplitude over the at least two occasions of demodulation reference signal transmission. A problem related to the object of using JCE, which involves measuring the DMRS transmitted at two or more occasions from the UE, is that to obtain coherent transmission (CT), such as stability of the DMRS over time, such as between the DMRS transmission occasions. Coherent transmissions greatly simplify JCE and improve its performance. The main reasons for this are the computational simplification and that consecutive DMRS observations are more strongly correlated. An entirely different class of JCE must be used if transmissions are not coherent. In order for coherent transmission to be obtained, it is important that a reference phase and amplitude for all transmission occasions does not drift or change abruptly, i.e., that the phase is continuous within a certain limit. However, preventing the phase from drifting is challenging.

In order to enable JCE it is considered critical that there is no transmission disruption on the channel that causes a phase or amplitude change in UL transmission, i.e. that certain parameters or settings are kept substantially constant among multiple PUSCH/PUCCH transmissions. Such parameters or settings may include one or more of transmission power, frequency domain resource allocation, DMRS antenna ports, codebook, Tx (transmission) spatial parameters, and timing advance (TA). In addition, transmission disruption may be caused by a time gap between two adjacent UL transmissions, such as for DL reception. If for instance TA is shifted, a real time clock in the UE is adjusted and this may cause a phase step. Within the 3GPP, discussions have been held on the ability to perform JCE across DL/UL switching slots. Here, it may be noted that Joint refers to using DMRS from different slots for estimating the channel of one given slot. In general, one cannot do that unless certain conditions are met. JCE may in this context refer to performing the channel estimation over multiple PUSCH/PUCCH jointly, where each PUSCH/PUCCH contains one or more DMRS occasions. Each DMRS occasion can be either a single symbol or two symbols in time domain, and typically each slot comprises a DMRS occasion. Performing joint channel estimation using DMRS from multiple PUSCH/PUCCH may provide better channel estimation than just performing estimation over a single PUSCH/PUCCH. According to initial simulations made by Sony and Ericsson, it can be concluded that JCE is possible for wideband signals. For narrowband signals, current discussions seem to converge towards requiring the UE to maintain phase consistency across UL/DL switching gaps, i.e. for reference DMRS transmitted at occasions before and after the gap. However, this is up to UE capability. If the UE is not capable of this, JCE is not possible.

Partly based on this objective, and with the general objective of improving the possibility of obtaining JCE in case of an UL transmission disruption, solutions are proposed herein which to allow for JCE even for UL signals transmitted on a narrow bandwidth from UEs uncapable of maintaining signal consistency over different reference signal, e.g. DMRS, occasions across a transmission disruption. In the context of various embodiments of these solutions, the term narrow bandwidth may mean a resource allocation of 1-2 Physical Resource Blocks (PRBs), i.e., 12-24 sub-carriers in the frequency dimension.

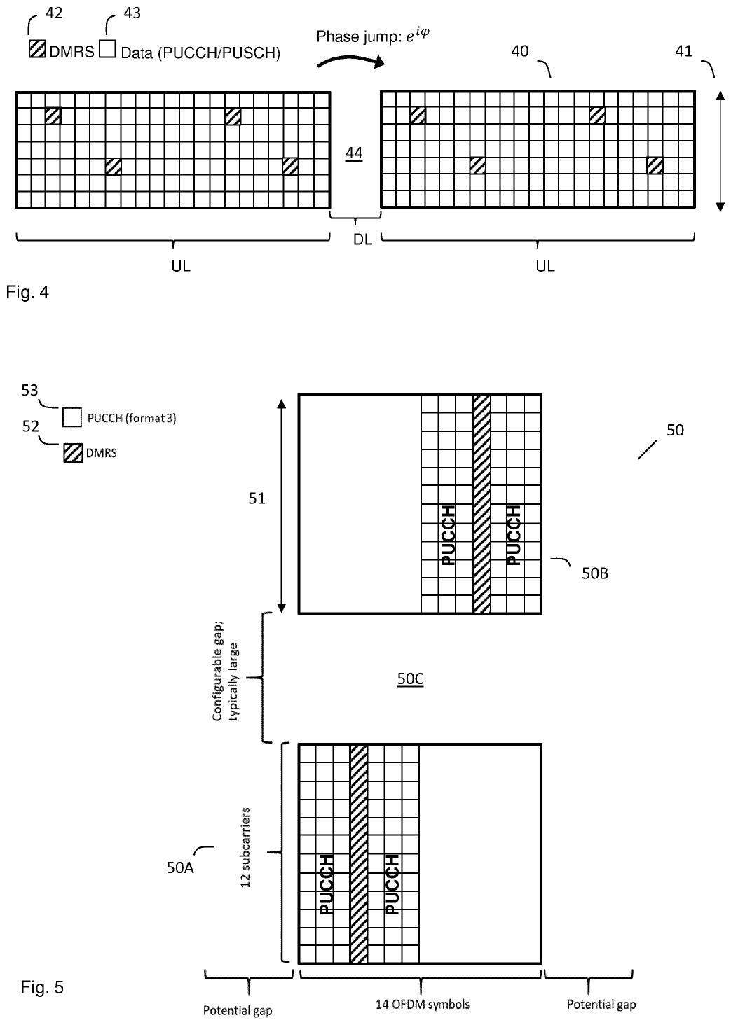

FIGS. 4 and 5 provide examples of scenarios wherein the proposed method may be employed to improve accuracy of channel estimation in the radio node 120, 20, and thereby improve SINR (Signal-to-Interference-plus-Noise Ratio).

FIG. 4 provides an illustration of an example of a narrowband UL signal according to a radio configuration 40 within a frequency domain allocation 41 of one PRB with resources 43 which may be allocated for UL transmission of data and first reference signal resources 42 allocated for DMRS. The radio configuration 40 provides for a transmission disruption 44 by means of a discontinuity for interrupting DL traffic. The drawing thus shows a general narrow bandwidth UL signal configuration with a portion of interrupting DL traffic, and provides one example of a scenario affected by an UL transmission disruption in which the proposed solution may be applied. The resource allocation shown in FIG. 4 may reflect an NR TDD (Time Division Duplex) system, wherein the configuration provides for switching between UL and DL transmissions. How frequently these changes occur is configurable.

The radio configuration 40 for UL signaling is provided to allocate various resources in time and frequency. The vertical direction indicates sub-carriers, and along the horizontal axis the drawing shows OFDM (Orthogonal Frequency Division Multiplexing) symbols in time. In each part of the UL signal there are DMRSs. Based on the DMRS, the radio node can estimate the UL channel, and then decode the data. However, as noted, the UE transmitter 2132 may lose phase consistency when it switches to DL reception, or alternatively, if it is switched off in the DL to save power. An immediate consequence is that the DMRS in the left part may not be usable for estimating the channel in the right part due to the unknown phase shift. Thus, channel estimation precision is degraded compared with a case where no phase shift is present.

FIG. 5 shows resource allocation for a channel configured to transmit an UL signal 50, which provides an example of DMRS allocation for a specific UL format known as PUCCH format 3. Resources 53 for UL signal transmission are provided in two segments 50A and 50B at different frequencies or carriers, separated by a configurable frequency gap 50C. Each allocated segment is confined within the frequency domain allocation 51 for the channel. For PUCCH, DMRS are mapped to RBs assigned for PUCCH transmissions, as provided in e.g., 6.4.1.3.2.2 of technical specification 38.211.

Simulations strongly indicate that for wide bandwidth UL signals, i.e. where the occupied part of the resource grid would be much taller, i.e. have a larger frequency domain allocation, and contain many more DMRS in the frequency domain than in the examples of FIGS. 4 and 5, the phase jump value φ can be accurately estimated, wherefore JCE is facilitated. It may be noted that channel estimation is in practice always done based on multiple DMRS observations made by the radio node-so multiple DMRSs is not what is meant with the word “joint” in JCE. If there are multiple slots available, then all DMRSs in all slots can be used for channel estimation. If DMRSs from multiple slots are used for estimation of channel coefficients in a given slot, we refer to this as JCE. A trivial solution to the problem of obtaining channel estimation could be to insert many more DRMS symbols on the channel, especially close in time to and after the transmission disruption. This would improve channel estimation so that no JCE is needed. However, this would also reduce spectral efficiency.

The invention is based on the insight that with an optimal estimator in a maximum likelihood (ML) sense, joint estimation of both the underlying propagation channel and the phase jump is strongly improved by having multiple DMRS along the frequency direction even for a narrowband channel. The optimal estimator would take all DMRS observations, of all DMRS transmission occasions, in all slots into account, and then produce an ML estimate of the channel coefficients. This includes handling the uncertainty presented by the phase jumps. What happens is that if there are many DMRSs is the frequency domain, is that the ML estimator can estimate the channel virtually as well as if the phase jump would not be present. This is a consequence of the phase jump being constant across all the frequencies, or rather the impact of a change in capacitance, i.e. phase, can be determined based on a known frequency dependency. In other words, the phase jump changes in a deterministic way across frequencies. That is, if the phase jump at frequency F1 is x, then the phase jump at any other frequency F2 is known (i.e., not random) and can be calculated from x.

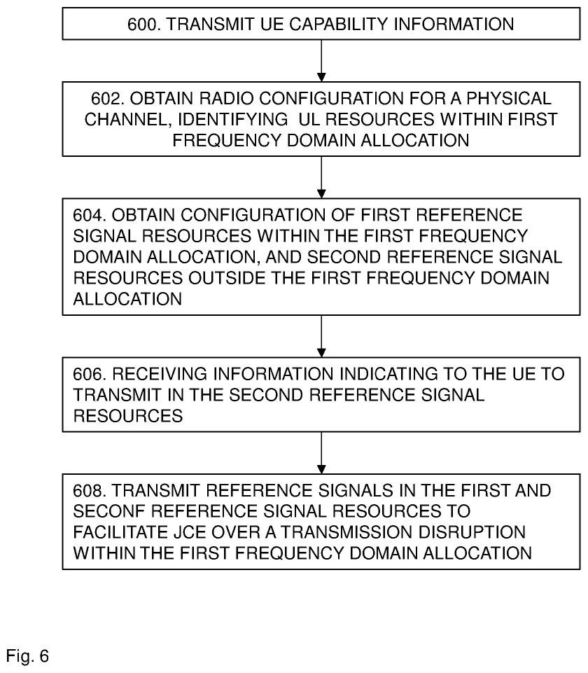

FIG. 6 shows a flow chart of various steps which may be included in different embodiments of the proposed solution, as carried out in the UE 10. According to one aspect, the proposed solution provides a method for facilitating joint channel estimation in the radio node 120, 20 of the wireless network 100. The method comprises:

Obtaining 602 radio configuration for a channel identifying resources for UL transmission within a first frequency domain allocation.

The radio configuration may be received in the UE 10 from the access node 120, and the channel may in some embodiments be PUSCH or PUCCH where the radio node is an access node 120. In a sidelink embodiment, UL transmission may refer to transmission from the UE 10 to UE 20, acting as the radio node. In such an embodiment, the channel may e.g. be a PSSCH (Physical Sidelink Shared Channel) or a PSCCH (Physical Sidelink Control Channel).

The method further comprises transmitting 608, in reference signal resources associated with the radio configuration, a reference signal, e.g. DMRS, for use in the radio node for joint channel estimation. Specifically, said reference signal resources comprise first reference signal resources allocated within said first frequency domain allocation, and second reference signal resources outside said first frequency domain allocation. The addition of second reference signal resources facilitates joint channel estimation over a transmission disruption within the first frequency domain allocation.

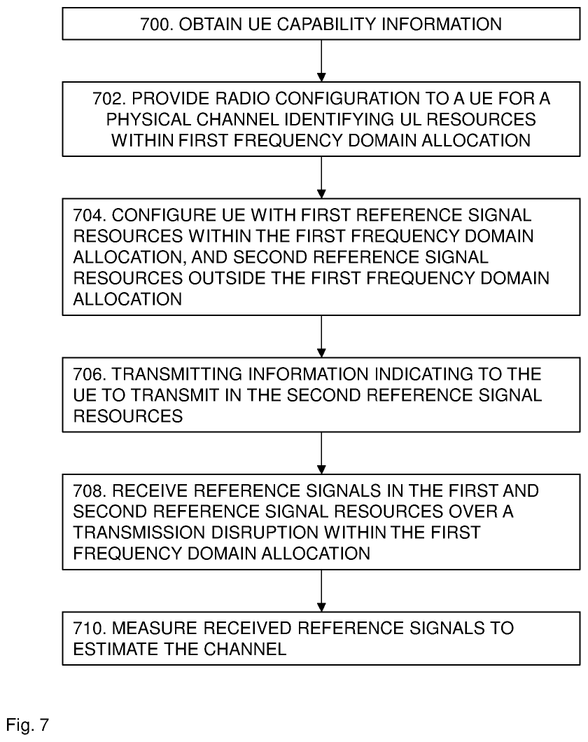

FIG. 7 shows a flow chart of various steps which may be included in different embodiments of the proposed solution as carried out in the radio node 120, 20. According to one aspect, the proposed solution provides a method for facilitating joint channel estimation in the radio node 120, 20 of the wireless network 100. The method comprises:

Providing 702, to the UE 10, radio configuration for a channel identifying resources for transmission within a first frequency domain allocation. Where radio node is the access node 120, the channel may in some embodiments be PUSCH or PUCCH. In a sidelink embodiment, UL transmission may refer to transmission from the UE 10 to UE 20, acting as the radio node. In such an embodiment, the channel may e.g. be a PSSCH or a PSCCH.

The method further comprises configuring 704 the UE to transmit, in reference signal resources associated with the radio configuration, a reference signal for use in the radio node for joint channel estimation, wherein said reference signal resources comprise first reference signal resources allocated within said first frequency domain allocation, and second reference signal resources outside said first frequency domain allocation to facilitate joint channel estimation over a transmission disruption within the first frequency domain allocation.

The proposed solution thus entails adding reference signal transmissions, such as DMRS transmissions, outside the currently allocated bandwidth of the first frequency resource allocation 41, 51. The technical effect obtained by this solution is that it resolves currently identified issues regarding JCE, as it will make the narrow bandwidth signal, such as signal 40 of or 50, equivalent to wide bandwidth signals, with respect to JCE. In this context, bandwidth is to be understood as the frequency domain allocation, i.e. the used frequency range(s), within which the UE 10 is configured to transmit signals 40, 50. For the case shown in FIG. 5, where the signal is not continuous across frequency, the bandwidth would be the frequency range 51 of each of the two non-contiguous bands containing the DMRSs. In other words, bandwidth means frequency-domain (FD) resource allocation (RA), e.g. for PUCCH/PUSCH transmissions. For example, this is determined by PUCCH-Resource.StartingPRB and PUCCH-format2.nrofPRBs, as provided in 3GPP technical specification 38.331. As of now, it is not possible to allocate DMRS outside the FD RA.

In some embodiments, the UE may obtain 604 the configuration of resource allocation of reference signals by receiving the configuration of said reference signal resource allocation from an access node 120 of the wireless network 100. In this context, the configuration of resource allocation of reference signals may be received in conjunction with receiving 602 the radio configuration of the channel 40, 50. Alternatively, specific information or messages, such as contained in DCI (Downlink Control Indicator), may be provided apart from the radio configuration and resource allocation of the channel 40, 50. In some embodiments, obtaining 604 comprises determining the configuration of resource allocation of reference signals, or at least said second reference signal resources, based on the radio configuration of the channel 40, 50, such as by table look-up in the UE 10. In some embodiments, configuration of the reference signal resource allocation may be conveyed by indicator signals in the DL, indicating a certain UL format. In some embodiments, the UE 10 thus receives indication of an UL format for the channel, which defines UL resources for signal transmission within the first frequency domain allocation, and additionally reference signal allocation of resources, comprising said second resources outside the first frequency domain allocation. The step of configuring 704 the UE 10 to transmit reference signals in reference signal resources, as described, may thus be obtained according to any combination of these embodiments. In some embodiments, the UE 10 may receive 606 an indication transmitted 706 from the radio node, to transmit in the second reference signal resources. This way, the radio node 120, 20 may be configured to selectively instruct the UE 10 to activate or deactivate transmission of reference signals outside the frequency domain allocation of the channel. In some embodiments, such indication may be transmitted 706 to the UE 10 based on a trigger in the radio node 120, 20. In some embodiments, the indication to the UE to transmit in the second reference signal resources may be transmitted 706 based on a determined radio distance from the radio node to the UE 10, such as by the access node 120 determining that the UE 10 is located in a cell edge region supported by the access node 120.

In some embodiments, the UE 10 is configured to report 600 UE capability information to the wireless network 100, wherein said UE capability information identifies whether the UE is capable of maintaining signal consistency over a transmission disruption. This may involve configuring UE capability information such that one or more parameters provide this indication. Such capability parameters may in various embodiments indicate capability of maintaining signal consistency over a transmission disruption dependent on one or more of transmission disruption type, transmission disruption length, UL transmission format, UL frequency band, and UL signal bandwidth. It may be noted, in this context, that UE capability information may have been conveyed to the wireless network 100 upon the UE 10 registering to the wireless network 100, or later by update signaling, through any access node of the wireless network 100. The radio node 120 may thus obtain 700 this capability information from storage, e.g. in the core network 110. In some embodiments, the radio node 120 may be configured to transmit 706, for reception 606 in the UE 10, the indication to the UE to transmit in the second reference signal resources, only responsive to the capability information not identifying UE capability to maintain signal consistency over the transmission disruption. In such an embodiment, the capability parameters not indicating capability of maintaining signal consistency over a transmission disruption may thus act as the mentioned trigger.

The proposed solution is provided for the general purpose of facilitating joint channel estimation in the radio node 120, 20 over a transmission disruption within the first frequency domain allocation, i.e. the bandwidth of the UL signal channel 40. In this context, it may be noted that the transmission disruption may comprise a time gap devoid of resources allocated for UL transmission to the radio node, and potentially comprising DL resources, as in the example provided in FIG. 4. In certain scenarios, the transmission disruption may comprise a discontinuity of UL transmission configuration in the UE, even other than a pure interruption of UL transmission. Examples of such a discontinuity of UL transmission configuration may comprise a change of one or more of transmit power in the transmitter 2132, timing advance adjustment of the transceiver 213, or a change of transmission beam direction. Generally speaking, the transmission disruption may be caused by any event which causes the phase or amplitude, meaning the reference phase or reference amplitude, of the UL signal to change over time. In at least some scenarios, such a transmission disruption may be defined by the radio configuration providing the resource allocation for the channel 40, such as being associated with a certain known point in time or time period associated with the radio configuration.

Various aspects of allocation of resources for reference signal transmission, according to the embodiments described herein will now be discussed, specifically how reference signals outside the bandwidth of the channel are added. It may be noted that the term DMRS will mainly be used to denote the reference signal for the sake of simplicity, but it should be understood that this is merely an example of a reference signal to be employed for the purpose of the proposed solution. Reference will moreover mainly be referred to the proposed solution as applied to the general channel format of FIG. 4, whereas similar and corresponding configuration may be applied to other signal formats, such as the format of FIG. 5.

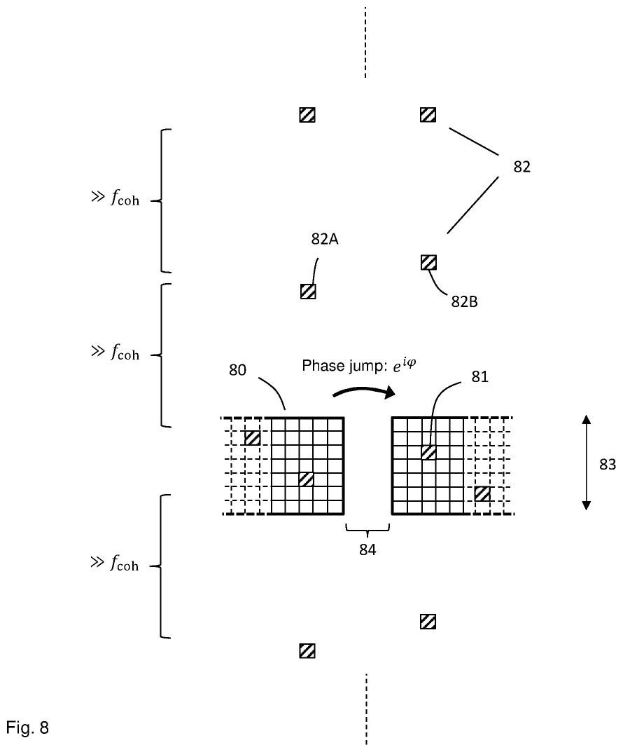

One beneficial solution, for channel estimation purposes, would be to place additional reference signal resources as close as possible to the frequency band of the channel 40 in which the UL transmission takes place. Or, in other words, just above or below the resource grid shown in FIG. 4. This would have as aim to estimate the channel not via JCE but do one estimation in the left block and one in the right block. However, from a resource scheduling perspective, it may be cumbersome to add DMRS close to the signal band 40 as it may be occupied by other UEs. For this purpose, various embodiments of the proposed solution entail that the additional DMRS resources (referred to herein as second reference signal resources) are placed farther away from the signal band than the frequency coherence bandwidth. In such a case, the only use of additional DMRS is to estimate the phase jump q. From simulations as well as theoretical considerations, it can be observed that it is superior to place the additional DMRSs far apart from each other. That is, they should not be placed in a group. Ideally, there should be at least one frequency coherence bandwidth of frequency spacing between them. Spacing the additional DMRSs in this way lead to superior estimation precision of φ. FIG. 8 schematically illustrates reference signal allocation according to one embodiment according to the proposed solution. Herein, radio configuration for a channel 80 comprises resources for Uplink, UL, transmission from the UE 10 within a first frequency domain allocation 83. Furthermore, reference signal resources 81, 82 are allocated for transmission of a reference signal usable for joint channel estimation at the radio node 120, 20. The reference signal resources 81, 82 are associated with the radio configuration in the sense that they are allocated in resources relative to, the allocation of the channel 80. The said reference signal resources comprise first reference signal resources 81 allocated within said first frequency domain allocation 83, and second reference signal resources 82 outside said first frequency domain allocation to facilitate joint channel estimation over a transmission disruption 84 within the first frequency domain allocation.

In some embodiments, the radio node 120, 20 configures resources 82 allocated in conjunction with a transmission disruption 84 for the UE 10 to transmit additional DMRS. Alternatively, the radio node 120, 20 may configure periodically, persistently, or semi-persistently allocated resources 82 to the UE 10, wherein the UE 10 is arranged to insert additional DMRS when needed in one or more of those periodically allocated resources, e.g. upon the occurrence of a transmission disruption 84.

The second reference signal resources 82, for additional DMRS transmission, may be allocated as close as possible to and/or after the transmission disruption in the time domain. According to one embodiment, the reference signal resources, or at least the second reference signal resources 82, are allocated in a resource partition within a predetermined range to the transmission disruption. In this context, the resource partition may be defined as one or more symbols, such as one or more identified symbols within a given slot or PRB, e.g. the slot adjacent to the transmission disruption. Alternatively, the resource partition may be defined as any symbol within the range to the transmission disruption. The range may e.g. be a predetermined number of symbols within a slot or PRB, or a predetermined number of slots. In some embodiments, the second reference signal resources 82 are allocated to the same symbol(s) as the first reference signal resources 81 in the time domain.

In various embodiments the reference signal resources are pairwise allocated in resource partitions prior to and after the transmission disruption. This is also illustrated in FIG. 8 for the second reference signal resources 82, indicated by the pair of resources 82A and 82B. In some embodiments, the pair of resources are allocated within a predetermined frequency range, such as within the same coherence bandwidth f_{coh}, or within the same frequency coherence block (of size f_{coh}), or allocated within the frequency range of a PRB, or within a predetermined number of subcarriers, such as e.g. 4 or less. In principle, correlation between the predetermined number of subcarriers should not have decayed too much. As an example, the correlation coefficient of the two channel coefficients should exceed a certain value, say, 0.9.

On the other hand, each pair of second reference signal resources 82 may be allocated far apart in the frequency domain, wherein each pairwise allocated resource partitions are displaced by a frequency spacing, defined by a predetermined spacing or as exceeding a predetermined spacing. A single DMRS 82, or DMRS pair 82A, 82B, per coherence bandwidth f_{coh} suffices, wherein the frequency spacing may be defined to exceed the coherence bandwidth for the channel. The predetermined spacing may in various embodiments be defined as a number PRBs or a number of subcarriers, such as 20, 50, 100 or other. It may be pointed out that without phase jumps, inserting resource allocation of these extra reference signals, e.g. DMRSs, far outside what we call “the bandwidth” is totally meaningless for channel estimation purposes.

In some embodiments, allocation of second reference signal resources 82 is applied based on bandwidth of the channel allocation 83, such as responsive to the bandwidth not exceeding a predetermined value, such as a corresponding to a number of PRBs, e.g. 1 or 2 PRBs.

In various embodiments, the second reference signal resources 82 for the added DMRSs outside the frequency domain allocation 83 for the channel may be borrowed from other UEs, that do not have coverage issues, i.e. the second reference signal resources 82 may be time multiplexed on carriers allocated to another UE. In this context, the resource allocation of the second reference signal resources 82 for the UE 10 may correspond to any resource within another frequency domain allocation for a different physical channel otherwise allocated but not temporarily used by said other UE. Alternatively, the second reference signal resources 82 for the added DMRSs outside the frequency domain allocation 83 for the channel may be added at empty bands where there is currently no traffic. In some embodiments, there are no resources allocated to the UE 1 for data transmission outside the signal band 83, except for the added DMRS 82.

Referring back to FIG. 8, the drawing is intended to show that the additional DMRSs at resources 82 are sparse in frequency, not close to the frequency domain allocation 83 of the signal band, not necessarily on the same subcarrier, and appear in a pair-one before and one after the DL gap. From simulations, we have observed that if 5-10 such pairs 82A, 82B are added, the phase jump caused by transmission disruption is no longer an issue: it can be estimated with high precision. These simulations were carried out on PUCCH at 4 GHz in a TDD system, as outlined in 3GPP Tdoc R4-211195 It may further be noted that without the phase jump, adding such DMRSs would be a complete waste of resources as they cannot be used to estimate the propagation channel in the signal band.

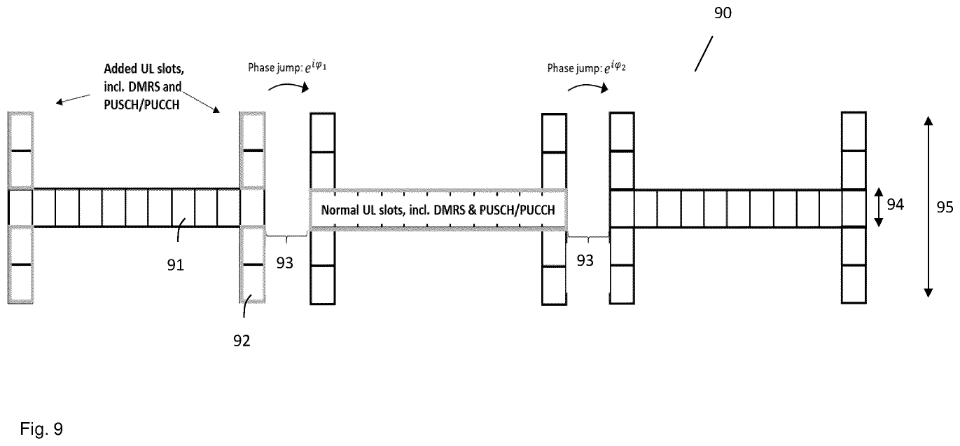

FIG. 9 illustrates another embodiment of the proposed solution. In this embodiment, a UE 10 suffering from lack of capability of maintaining e.g. phase consistency over a transmission disruption can be provided with a special type of resource allocation. Also in this embodiment the resource allocation may be applied in accordance with what was described and exemplified above with reference to FIG. 8, wherein the reference signal resources 82 may be allocated in a resource partition within a predetermined range to the transmission disruption, as described an exemplified above, and wherein said reference signal resources may be pairwise 82A, 82B allocated in resource partitions prior to and after the transmission disruption, and wherein each pairwise allocated resource partitions are displaced by a frequency spacing. However, in this embodiment relies on the idea of scheduling the UE 10 with a special PRB pattern to make JCE across a transmission disruption, such as a transmission gap, feasible. It may be noted that individual resource partitions, such as symbols, allocated for reference signals are not specifically shown in FIG. 9, but are typically comprised in each PRB.

In the embodiment of FIG. 9, the radio configuration allocates resources for UL transmission in one or more first resource blocks 91 within the first frequency domain allocation 94, and one or more second resource blocks 92 outside the first frequency domain allocation 94 adjacent to the transmission disruption 93. Said one or more second resource blocks 92 comprise said second resources 82 for reference signal transmission.

This way, at the transmission disruption, such as both before and after the transmission disruption, the UE 10 is scheduled with more PRBs in frequency, such as within a bandwidth of a second frequency domain allocation 95. This way, phase jumps can be accurately learned.

In this case, it is preferable to have the additional PRB close in frequency to each other. This is so since the channels at the additional PRBs must be estimated, and then it is important to be able to utilize the DMRSs in neighboring PRBs. Therefore, they shall be further away from each other than a frequency coherence bandwidth. In some embodiments, the frequency interval between pairs of second resources 82 for reference signal transmission is one physical resource block, PRB.

The efficiency of estimating the phase jump decreases slightly, compared to the embodiment of FIG. 8 since the PRBs are not far apart but is still reasonably good.

In a variant of the embodiment of providing a radio configuration which includes additional scheduling of resources adjacent to the transmission disruption 93, the UE 10 is configured with a comparatively small BWP (bandwidth part) corresponding to the bandwidth 94 for the data transmission in resources 91, while a comparatively larger BWP corresponding to the bandwidth 95 is scheduled when additional DMRS are to be transmitted in resources 92. In one example, such an embodiment entails that the radio configuration identifies a first BWP comprising said first frequency domain allocation 94, the method further comprising:
switching to a second BWP, having a center frequency in common with the first BWP, to allocate resources in said second resource blocks 92 adjacent to the transmission disruption.

Such an embodiment requires fast BWP switching from UE side compared to existing BWP switching. Considering that such a switch does not change the center frequency of the transmission band, the RF component re-tuning time of the transmitter 2132 can be reduced, which facilitates enablement of this embodiment.

In one example, this embodiment benefits from a BWP activate/deactivate mechanism or signaling, whereby the UE 10 is configured to switch between BWP states smoothly. Such an embodiment may comprise that the UE 10 receives, from the radio node 120, control data for switching between the first and second BWPs dependent on resource block.

Currently, the UE 10 needs to wait for radio node RRC (Radio Resource Control) signaling or a timer to activate/deactivate a BWP. In contrast, the described embodiment provides that the radio node indicates directly to the UE to use different BWP for different resource blocks or time slots. This way, the UE 10 can smoothly switch BWP at the slots or resource blocks adjacent the transmission disruption 93 without requiring further signaling.

UEs at cell edge are typically scheduled with narrow bandwidth. In such a scenario, the UE can allocate all power to this narrow bandwidth and thereby obtain better power density (i.e. coverage). Adding, a few DMRS signals outside this bandwidth is not expected to decrease the power density as the bulk of the signal is still within a narrow BW. Conversely, as JCE is used to enhance UL coverage, the proposed solution provides improved ability of the UE 10 to operate in a narrow BW, and thereby to improve coverage.

According to the proposed solution, a UE 10 may be allocated a special transmission format by the radio node, so as to provide additional reference signal resources outside the frequency domain allocation for the channel. This may in various embodiments be configured based on the UE 10 reporting lack of capability of maintaining phase consistency.

For the embodiments described with reference to both FIG. 8 and FIG. 9, a number of standard formats may be defined for use when the radio node configures the UE 10 with additional DMRSs. This can be done, e.g., by extending PUCCH-Resource, PUCCH-format2, etc., in technical specification 38.331. For example, in the embodiments described with reference to FIG. 8, the access node 120 can indicate the following to the UE 10: number of additional DMRS, a constant frequency spacing among all DMRSs, time location before/after the transmission disruption, starting subcarrier for additional DMRSs, etc. Selected values of the aforementioned parameters can be termed “scheme A, scheme B” etc. For example, “scheme A” could indicate that the UE should add 10 additional DMRSs, 5 below the signal band and 5 above, with a frequency spacing of 50 subcarriers among the DMRS, and that the first additional DMRS should be placed 50 subcarriers above the DMRS already in the signal band. For PUCCH format 3, depicted in FIG. 5, the standard forms mentioned above could mean that more DMRS blocks are added in the configurable gap. The number of such blocks and their spacings can be taken from a codebook. For the embodiment described with reference to FIG. 9, the radio node can indicate only the number of PRBs to be added above and/or below the signal band. In some embodiments, the proposed solution of adding additional resources for DMRS is applied responsive to the first frequency domain allocation having a bandwidth of a predetermined size, such as not exceeding 1, 2, 3 or another number of physical resource blocks, PRBs.

Various features and functions of different embodiment are presented herein. Except where clearly contradictory, these features and functions can be combined in any way, including the combinations provided in the claims.

1. A method carried out in a User Equipment (UE), for facilitating joint channel estimation in a radio node of a wireless network, the method comprising:
obtaining radio configuration for a channel, identifying resources for Uplink (UL), transmission within a first frequency domain allocation;
transmitting, in reference signal resources associated with the radio configuration, a reference signal for use in the radio node for joint channel estimation,
wherein said reference signal resources comprise first reference signal resources within said first frequency domain allocation, and second reference signal resources outside said first frequency domain allocation to facilitate joint channel estimation over a transmission disruption within the first frequency domain allocation.

2. The method of claim 1, comprising: receiving configuration of said reference signal resources from an access node of the wireless network.

3. The method of claim 1, comprising: determining configuration of at least said second reference signal resources based on the radio configuration of the channel.

4. The method of claim 1, comprising: receiving, from the radio node, an indication to the UE to transmit in the second reference signal resources.

5. The method of claim 4, comprising: transmitting-UE capability information to the wireless network, wherein said indication is received based on the UE capability information not identifying UE capability to maintain signal consistency over the transmission disruption.

6. The method of claim 1, wherein said reference signal resources are allocated in a resource partition within a predetermined range to the transmission disruption.

7. The method of claim 1, wherein said reference signal resources are pairwise allocated in resource partitions prior to and after the transmission disruption.

8. The method of claim 7, wherein each pairwise allocated resource partitions are displaced by a frequency spacing.

9. The method of claim 8, wherein said frequency spacing exceeds a coherence bandwidth for the channel.

10. The method of claim 1, wherein said second reference signal resources are pairwise allocated within a predetermined frequency range.

11. The method of claim 1, wherein said radio configuration allocates resources for UL transmission in one or more first resource blocks within the first frequency domain allocation, and one or more second resource blocks outside the first frequency domain allocation adjacent to the transmission disruption, wherein the one or more second resource blocks comprise said second resources for reference signal transmission.

12. The method of claim 11, wherein said reference signal resources are pairwise allocated in resource partitions prior to and after the transmission disruption,
wherein each pairwise allocated resource partitions are displaced by a frequency spacing, and
wherein the frequency interval is one physical resource block (PRB).

13. The method of claim 11, wherein the radio configuration identifies a first bandwidth part (BWP), comprising said first frequency domain allocation, the method further comprising: switching to a second BWP, having a center frequency in common with the first BWP, to allocate resources in said second resource blocks adjacent to the transmission disruption.

14. The method of claim 13, comprising: receiving, from the radio node, control data for switching between the first and second BWPs dependent on resource block.

15. The method of claim 1, wherein the first frequency domain allocation has a bandwidth of one to two physical resource blocks (PRBs).

16. The method of claim 1, wherein the transmission disruption comprises a time gap devoid of resources allocated for UL transmission to the radio node.

17. The method of claim 1, wherein the transmission disruption comprises a discontinuity of UL transmission configuration in the UE.

18. The method of claim 17, wherein the discontinuity of UL transmission configuration comprises a change of one or more of transmit power, timing advance adjustment, or beam direction.

19. The method of claim 1, wherein said transmission disruption is defined by said radio configuration.

20-21. (canceled)

22. A method carried out in a radio node of a wireless network for facilitating joint channel estimation in communication with a User Equipment (UE), the method comprising:
providing, to the UE, radio configuration for a channel identifying resources for Uplink (UL), transmission within a first frequency domain allocation;
configuring the UE to transmit, in reference signal resources associated with the radio configuration, a reference signal for use in the radio node for joint channel estimation,
wherein said reference signal resources comprise first reference signal resources allocated within said first frequency domain allocation, and second reference signal resources outside said first frequency domain allocation to facilitate joint channel estimation over a transmission disruption within the first frequency domain allocation.

23-40. (canceled)
